(19) United States
(12) Patent Application Publication
(10) Pub. No.: US 2002/0138605 A1
(43) Pub. Date: Sep. 26, 2002

(54) Message tracking system and method

(76) Inventor: Steve Hole, Edmonton (CA)

Correspondence Address: BAKER & MCKENZIE, 805 THIRD AVENUE, NEW YORK, NY, 10022, US

(21) Appl. No.: 09/765,927

(22) Filed: Jan. 19, 2001

(51) Int. Cl. G06F 15/173

(52) U.S. Cl. 709/224

(57) ABSTRACT

A message tracking system and method for collecting and compiling information regarding the transfer and handling of messages, e.g., electronic mail messages, into a decision support subsystem or application is provided. The information may be used to analyze the reliability of the transport and handling method used for transferring a particular electronic message. The message tracking system includes a message tracking monitor for monitoring tracking information. The tracking information is collected and transmitted to a decision support subsystem and/or applications. The decision support subsystem and/or application may include a message tracking decision support database for storing the tracking information. A message tracking interface may be used to manage and access the message tracking monitor and the message tracking decision support subsystem/applications. The message tracking system and method of the present invention accepts and/or requests tracking information from a number of diverse sources, processes the information and provides the information to applications desiring such information.

### TECHNICAL FIELD OF THE INVENTION

The present invention relates generally to messaging systems, and more particularly, to message tracking system and method.

### BACKGROUND OF THE INVENTION

Presently, numerous business entities use the Internet-wide messaging infrastructure, e.g., electronic mails, to conduct business transactions globally over the Internet. To these businesses desiring to use the Internet messaging as a reliable data transport service, it becomes important to be able assess and understand the reliability of such messaging infrastructure.

One of the key requirements for establishing reliability in Internet messaging is message tracking. Message tracking refers to the ability to trace the path that a particular message has taken through a messaging system and the current routing status of that message. Message tracking provides for the ability to quickly locate where a message is and to determine whether or not the message has been delivered to its final destination. Message tracking can also provide the information needed for an application to respond to delivery failures and delays in a way suitable to the policies of the application.

The Internet Engineering Task Force (“IETF”) is currently proposing message tracking models and protocols to provide message tracking solutions that can be used with the Internet-wide message infrastructure. For example, an extension to Simple Mail Transfer Protocol (“SMTP”) is defined to provide a message tracking service. An extended SMTP server may implement this service extension by propagating message tracking information when relaying mail to other SMTP-based message transfer agents (“MTA”) and by making a “best effort” to record when messages are passed into other environments. Message tracking models are described in www.ietf.org. The work described by this organization is an example of one source of tracking electronic transmission of data.

With such message tracking sources available, it is desirable to have a system and method for collecting and processing the tracking information, e.g., into a decision support database. A decision support system is a computer program application that analyzes business data and presents it so that users can make business decisions more easily. With the message tracking service available, it is desirable to have a message tracking decision support system for analyzing and assessing reliability of Internet messaging for the businesses that desire to use Internet messaging as a data transport service.

### SUMMARY OF THE INVENTION

The present invention is directed to a message tracking system and method for compiling information regarding the transfer and handling of messages, for example, electronic mail (e-mail) messages, message transactions on the Internet and/or proprietary systems, into a decision support subsystem. The information may be used to analyze the reliability of the transport and handling method used for transferring a particular electronic message. The method and system of the present invention may also be used to build exception handling, reporting, and business logic applications.

The message tracking system of the present invention accepts and/or requests tracking information from a number of diverse tracking sources. The tracking information may be further processed to meet the specification of an application desiring to use that information. The message tracking system of the present invention includes a message tracking monitor for monitoring tracking information. The tracking information is collected and transmitted to a message tracking decision support subsystem which may include a message tracking decision support database. The message tracking decision support subsystem receives the tracking information and processes the information. For example, depending on the content of the tracking information, the message tracking decision support subsystem may generate an alert signal, generate a report, or notify another system, e.g., a system administrator. A message tracking interface may be used to manage and access the message tracking monitor and the message tracking decision support subsystem or database.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 illustrates an exemplary system architecture in one embodiment of the present invention;

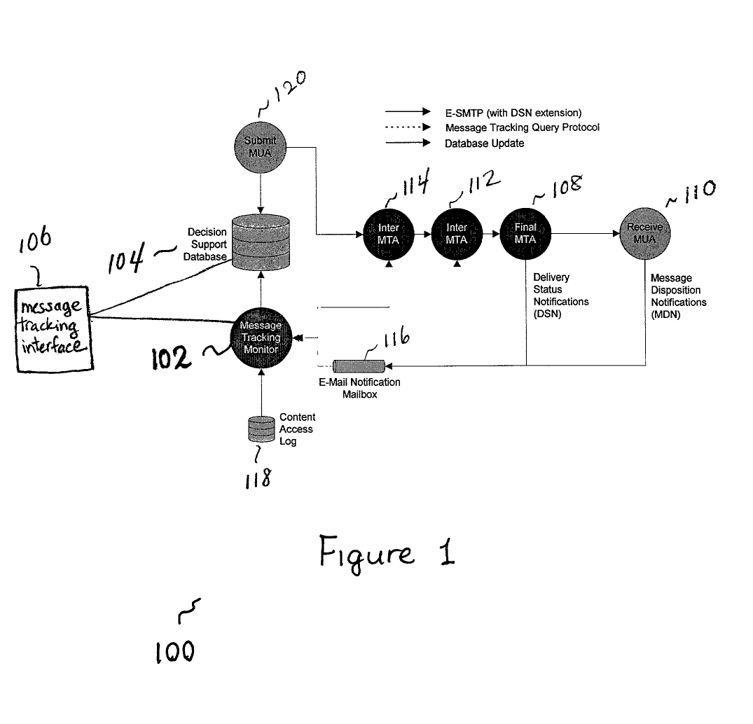

FIG. 2 illustrates an example of a distributed message tracking monitor architecture in one embodiment of the present invention;

FIG. 3 is an architectural diagram illustrating components of the message tracking system in one embodiment of the present invention; and

FIG. 4 is an architectural diagram illustrating pluggable message tracking interface in one embodiment of the present invention.

### DETAILED DESCRIPTION OF THE PREFERRED EMBODIMENT OF THE INVENTION

Definition of Terms

Mail User Agent (“MUA”)—MUA is a program that allows a user to compose and read electronic mail messages. MUA typically runs on the user's desktop.

Message Transfer Agent (“MTA”)—MTA is a program responsible for delivering electronic mail (“e-mail”) messages. MTA receives a message from a MUA or another MTA and transfers towards its destination. The destination may be local in which case the message is delivered, or the destination may be reached by routing the message to another MTA. MTA may store the message temporarily in its local storage before transferring the message further.

Intermediate message transfer agent—an intermediate MTA is an MTA that accepts a message for transfer to another location.

Final Message transfer agent—a final MTA is an MTA that accepts a message for local delivery. It is the final place that a message is accepted. The final MTA may send any delivery status notifications (“DSNs”).

Delivery status notification (“DSN”)—A delivery status notification is produced by an MTA when a message is unsuccessfully delivered, either to its next hop or the final message store, or when it is unsuccessfully delivered.

Message disposition notification (“MDN”)—A message disposition notification is used to report the disposition of a message after it has been successfully delivered to a recipient.

Message tracking query protocol (“MTQP”)—MTQP is a protocol that can be used to query the status of messages that have been transmitted on the Internet via SMTP.

Secure Multi-Purpose Internet Mail Extensions (“S/MIME”)—S/MIME is a secure method of sending electronic mail that uses the Rivest-Shamir-Adleman (RSA) encryption system. S/MIME is included in the commercially available Web browsers.

Extended Security Service (“ESS”)—ESS is layered on top of S/MIME and includes functions for providing secure read receipts of messages.

Message Tracking Decision Support System

The present invention is directed to collecting information about the Internet electronic mail (e-mail) messages, e.g., their transfer path, delivery results, and user access history. The information collection may be performed as a result of accepting requests from an application desiring to have the information. In the present invention, tracking information is collected from a number of sources that may contain all or some of the tracking information. For example, these tracking information may include reporting MTA, arrival date, original recipient address, final recipient (after forward or gateway) address, delivery action performed, accessing user, and access action performed. Collected data is processed by, e.g., parsing into an internal record schema (structure), and transmitted to a decision support subsystem which may handle the messages specific to each subsystem requirements. These requirements may include, e.g., depending on the content of the information, performing exception handling, generating a notification to a system administrator, and/or generating a report, etc. The information may also be deposited into a decision support database. The decision support database may be accessible to applications, e.g., which perform exception handling processes, reports, statistics, and operational management.

In one embodiment, the present invention includes a message tracking monitor (“mtrkmon”) 102 which, e.g., example, may be a module or a software application, but not limited to such, that monitors, e.g., well known tracking information ports where tracking notifications and/or information are sent, posted, or otherwise signaled. The monitoring of these ports may be performed periodically or continuously. Examples of tracking notifications include Delivery Status Notifications (DSN), Message Disposition Notifications (MDN), Internet Message Tracking Query Protocol (MTQP) responses and other common but non-standard delivery and non-delivery notifications. Examples of well known tracking information ports include: Internet mail addresses and corresponding mailboxes; Message Tracking Servers associated with Internet Message Transfer Agents (MTA); and access status logs for HTTP document queries. Message Tracking Servers provide direct, interactive tracking information to tracking agents using the Message Tracking Query Protocol (MQTP). Access status logs for HTTP document queries generally describe the accessing user, date of access, and access action, similar to the information provided by Message Disposition Notifications (MDN). The collecting of tracking information may be performed, e.g., by reading or accessing notification messages in a mailbox, by posting a read statement on a log file, by executing a query against a message tracking server or a query interface that communicates with a proprietary message system, or by listening in on any other data sources having the tracking information.

In one embodiment of the present invention, notifications that are sent to the tracking ports are collected and processed into a standard data form that is suitable for passing to the decision support subsystem. Further, in one embodiment, processed data may be stored in a message tracking decision support database (“mtrkdb”) 104. For example, the message tracking decision support database 104 may be a fixed schema database that includes a set of records that describe the complete history of transport and handling of a message submitted to the Internet electronic mail system. An example of this history may include the transfer and access state of the message, including date and time of movement from one state to another. An example of a typical state transition for an internet mail message that is successfully delivered and accessed by the final recipient might look like:

| Status | Host_Name | User_Name | Time Stamp |
|---|---|---|---|
| Submitted | mbilldemo.messagingdirect.com | pers@messagingdirect.com | Thu Mar 2 |
| | | | 10:15:23 2000 |
| Delivered | polski.esys.ca | recv@esys.ca | Thu Mar 2 |
| | | | 15:26:51 2000 |
| Accessed | client.esys.ca | revc@esys.ca | Fri Mar 3 |
| | | | 08:32:21 2000 |

The information includes the submission, delivery, and access time of the message, the users submitting and accessing the message, and the host systems that sent and received the message.

A message tracking interface 106, e.g., may include one or more software modules to provide an application programming interface to the message tracking decision support system. In one embodiment, it acts as an intermediary between the decision support subsystem 104 and the message tracking monitor 102 and/or other message tracking data collection application. The message tracking interface 106, e.g., may provide for accessing and updating information in a message tracking decision support database 102. The message tracking interface 106 may include software modules for simultaneously communicating to multiple different decision support subsystems by e.g., employing multithreaded programming techniques. Decision support subsystems may be real time exception handling applications that wish to act immediately on notification of failed delivery, access or other message handling events.

The message tracking interface 106 also may be used to manage the processing and operations of the message tracking monitor 102. For example, the message tracking interface 106 may communicate to the message tracking monitor 102 the identification of the tracking information ports, types of tracking information to monitor for and instructions for overall execution control of the message tracking monitor. Examples of execution control include starting/stopping the message tracking monitor, detecting when a message tracking monitor instance is hung-up and restarting the instance, and reloading or reconfiguring configuration parameters for running the message tracking monitor such that different instances of the monitor may run differently with different parameters, e.g., Web-based or application-based. Information ports include mailboxes that tracking notifications are received on, and TCP connection ports for synchronous tracking queries using the Message Tracking Query Protocol (“MTQP”).

The system of the present invention may collect the tracking information from a variety of data sources. Examples of data sources include, but are not limited to, standard based delivery status and message disposition notifications (DSN and MDN) issued asynchronously by Internet Message Transfer Agents (“MTA”) 108 and Internet Mail User Agents (“MUA”) 110; standards based interactive message tracking queries using the Internet Message Tracking Query Protocol (“MTQP”); standard based disposition notifications issued asynchronously by Internet Mail User Agents (“MUA”) via S/MIME-ESS secure receipts; other content access linkages, including specifically, access of specified embedded graphical content using HTML links and references.

Each instance of the message tracking monitor 102 in the present invention collects tracking notifications from a tracking notification port 108, 110, 112, 114, 118, 120. The system of the present invention is enabled to track any number of types of tracking ports and any number of tracking ports of a particular type. Each instance of the message tracking monitor 102 may process raw tracking data that it receives on the tracking notification port into a tracking status record. For example, the computer parseable part of a raw Delivery Status Notification (DSN), e.g.,

Reporting-MTA: dns; rembrandt.esys.ca

Received-From-MTA: DNS; kepler.esys.ca

Arrival-Date: Thu, Jan. 18, 2001 10:56:25-0700

Final-Recipient: RFC822; invalid@messagingdirect.com

Action: failed

Status: 5.1.1

Diagnostic-Code: SMTP; 550 5.1.1 User unknown

Last-Attempt-Date: Thu, Jan. 18, 2001 10:56:25 -0700,

is extracted from the message, parsed, and transmitted to a decision support subsystem via the message tracking interface. The parsed message may be written as a data record into the decision support database 104 in one embodiment.

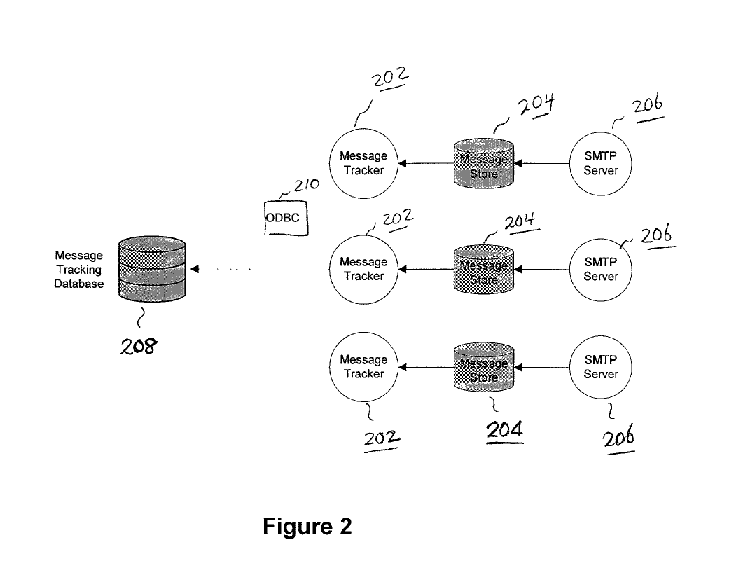

FIG. 2 illustrates an example of a distributed message tracking monitor architecture in one embodiment of the present invention. Each message tracking monitor 202 monitors various ports, e.g., message stores 204, updated by mail servers, e.g., SMTP servers 206.

In an exemplary embodiment, the components of the message tracking decision support system of the present invention interact using secure network protocol connections, thus allowing for wide geographic distribution and distribution over public networks such as the Internet. In an exemplary embodiment, security is enforced, e.g., by authenticated connections to prevent unauthorized access to the system, data integrity checks to prevent hijacking and modification and/or substitution of fraudulent data, and an encryption scheme to prevent unauthorized access to data. Any known authenticated connections, data integrity checks, and encryption schemes may be used to enforced security in the present invention.

In an exemplary embodiment, the collecting and compiling of the tracking information in the present invention may be separated from the tracking data itself. For example, data processed by the collection and compiling function may be passed to a real time decision support application rather than storing it in a database. Both the data collection function and the decision support subsystem or mechanism in one embodiment of the present invention are replaceable modules, e.g., pluggable software modules, that coordinate through the message tracking interface. In one embodiment of the present invention, a plurality of data collection applications may feed data simultaneously to many decision support subsystems or mechanisms. Accordingly, the system of the present invention may serve as a single interface to applications that desire to have tracking information from a plurality of tracking sources.

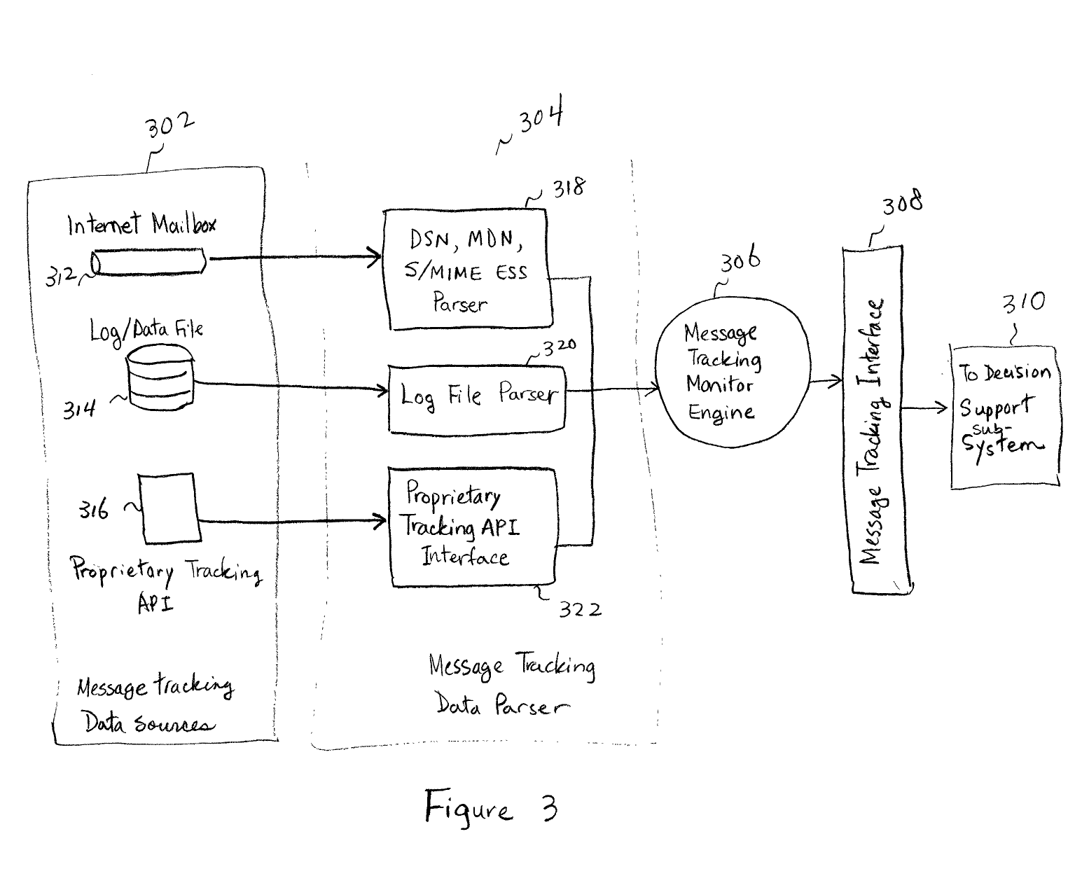

FIG. 3 is an architectural diagram illustrating components of the message tracking system in one embodiment of the present invention. The message tracking data sources 302 are locations or sources from which message tracking information may be obtained. As illustrated, the message tracking data sources 302 include, but are not limited to, the Internet mailbox 312, log/data file 314, and/or proprietary tracking API 316. These locations or sources may include standard and proprietary data formats and/or programming interfaces. An example of a proprietary tracking API 316 is IBM MQ Series. Using the API available from the IBM MQ Series, IBM tracking records may be obtained. An example of a standard data sources is an Internet Mailbox 312.

Message tracking data parsers 304 include, but are not limited to, software modules that parse raw message tracking data into a common message tracking record. These modules may be specifically programmed to parse a specific type of raw message tracking data. For example, a DSN, MDM, S/MIME, or ESS parser 318 receives and parses messages recorded in these formats. A log file parser 320 parses data written in a log or data file formats. Similarly, a proprietary tracking API interface 322 parses data received from a proprietary tracking API. Although the parser 304 is described as one or more software modules, those skilled in the art will appreciate that the modules may be implemented in other embodiments, e.g., as firmware.

The parsed messages are transmitted to a message tracking monitor engine 306. The message tracking monitor engine 306 is responsible for posting message tracking records received from the data parser modules 304 into a decision support subsystem. The message tracking monitor engine 306 also may include a control logic for starting, stopping, and/or configuring both the data parsers 304 and the message tracking interface 308. The message tracking monitor engine 306 may be a software module, however, it will be appreciated by those skilled in the art that the message tracking monitor engine 306 need not be limited to such. For example, the message tracking monitor engine 306 may be implemented as firmware.

The message tracking interface 308 connects the message tracking monitor engine 306 to one or more decision support subsystems 310. The message tracking interface 308 acts as data switching interface for posting message tracking records to one or more decision support applications and/or subsytems 310. The message tracking interface 308 may be a software module, however, it will be appreciated by those skilled in the art that the message tracking interface 308 need not be limited to such. For example, the message tracking interface 308 may be implemented as firmware.

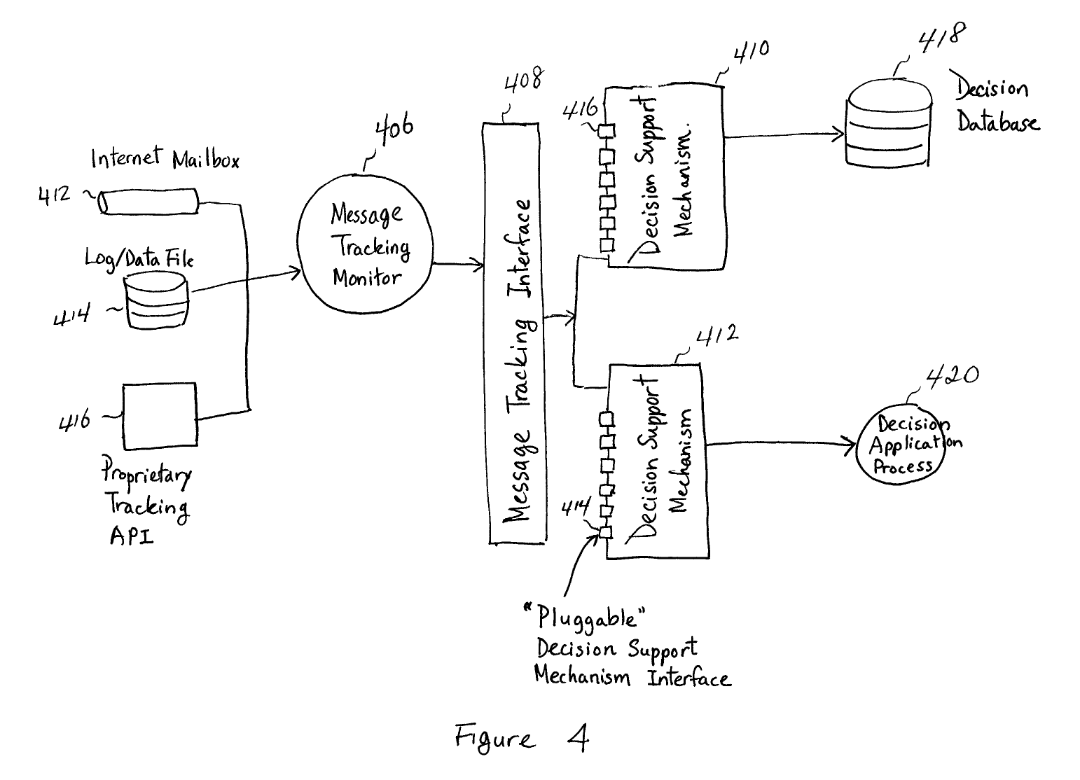

FIG. 4 is an architectural diagram illustrating pluggable decision support mechanism interface in one embodiment of the present invention. The tracking information received from one or more data sources 412, 414, 416 and parsed by the message tracking monitor 406 are transmitted via the message tracking interface 408 to one or more decision support subsystems and/or applications. The present invention in one embodiment may also include one or more decision support mechanism interface 410, 412 to function as an application interface program (API) for connecting decision support subsystems and/or applications 418, 420 into the message tracking system of the present invention, e.g., via the message tracking interface 408.

The decision support mechanism interface 410, 412 allows multiple decision support systems, e.g., subsystems and/or applications, having different functionality, to be connected to and receive data from the message tracking monitor 406 at the same time. Accordingly, from the same data delivered by the message tracking monitor 406, different business processing logic and policies may be implemented or developed by different decision support mechanism interfaces 410, 412 to meet respective business requirements. For example, one decision support subsystem or application via a decision support mechanism interface 410 may store all tracking data in a database 418 for later processing, e.g., reporting, statistical applications, etc. Another decision support subsystem or application 420 via its decision support mechanism interface 412 may decide to act on the data received in real time, e.g., by performing real time exception handling on failed message deliveries or causing the message content to be delivered via another medium, e.g., paper or facsimile.

The decision support mechanism interface 410, 412 may include pluggable modules 414, 416 which may be dynamically added or modified, e.g., as dynamic link library (“DLL”) modules, to the existing decision support mechanism interface 410, 412. The pluggable modules 414, 416 of the present invention greatly simplify the process of modifying the decision support mechanism interface 410, 412, e.g., when business requirements or needs change, thereby allowing customization of and extensibility to the system according to individual business needs.

It will be appreciated by those skilled in the art that the various components and modules of the present invention described with reference to the figures may be implemented in a distributed environment connected via the LAN, WAN, Internet, Intranet, and/or Extranet and is not limited to any one networking infrastructure. It will also be appreciated by those skilled in the art that the present invention may be implemented in a conventional programming such as C Programming Language or in an object oriented language such as C++ or Java, utilizing, e.g., interprocess communication and multithreading techniques available on various computer Operating Systems.

While the invention has been particularly shown and described with respect to a preferred embodiment thereof, it will be understood by those skilled in the art that the foregoing and other changes in form and details may be made therein without departing from the spirit and scope of the invention.

I claim:

1. A message tracking system, comprising:
a message tracking monitor operable to monitor one or more ports for tracking information;
a message tracking interface coupled to the message tracking monitor and enabled to communicate with one or more decision support subsystems, the message tracking interface operable to receive tracking information from the message tracking monitor and transfer the tracking information to one or more decision support subsystems,
wherein the tracking information is collected and managed.

2. The message tracking system as claimed in claim 1, wherein the one or more ports include any one or combination of electronic mail address, message tracking server, access status log, and proprietary message tracking API.

3. The message tracking system as claimed in claim 1, wherein the decision support subsystem includes a decision support database.

4. The message tracking system as claimed in claim 1, wherein the decision support subsystem includes a decision support application.

5. The message tracking system as claimed in claim 1, wherein the tracking information includes one or more tracking notifications.

6. The message tracking system as claimed in claim 1, wherein the message tracking interface is operable to access the tracking information stored in a decision support database.

7. The message tracking system as claimed in claim 1, wherein the message tracking interface is operable to update the tracking information stored in a decision support database.

8. The message tracking system as claimed in claim 1, wherein the message tracking interface is operable to manage the message tracking monitor.

9. The message tracking system as claimed in claim 1, wherein the system further includes one or more dynamically pluggable decision support interfaces.

10. A method for tracking message, comprising:
monitoring tracking information on one or more ports;
collecting tracking information from the one or more ports; and
transmitting the tracking information for handling the tracking information according to a predetermined schema.

11. The method for tracking messages as claimed in claim 10, wherein the one or more ports include one or more electronic message tracking ports.

12. The method for tracking messages as claimed in claim 10, further including:
parsing the tracking information into a record format.

13. The method for tracking messages as claimed in claim 10, wherein the predetermined schema includes storing in a decision support database.

14. The method for tracking messages as claimed in claim 10, wherein the predetermined schema includes real time exception handling.

15. The method for tracking messages as claimed in claim 10, wherein the transmitting includes transmitting the tracking information to a decision support subsystem.

16. The method for tracking messages as claimed in claim 10, wherein the one or more ports include one or more tracking ports.

17. The method for tracking messages as claimed in claim 10, further including providing analytical reports based on the collected tracking information.

18. The method for tracking messages as claimed in claim 10, wherein the monitoring includes requesting for one or more tracking notifications from one or more tracking sources.

19. The method for tracking messages as claimed in claim 10, wherein the monitoring includes accepting one or more tracking notifications from one or more tracking sources.

20. The method for tracking messages as claimed in claim 10, wherein the monitoring includes continuously monitoring tracking information ports.

21. A program storage device readable by machine, tangibly embodying a program of instructions executable by the machine to perform method steps of tracking messages, comprising:
monitoring tracking information on one or more ports;
collecting tracking information from the one or more ports; and
transmitting the tracking information for handling the tracking information according to a predetermined schema.

22. A message tracking system, comprising:
a message tracking monitor coupled to one or more message tracking data sources, the message tracking monitor operable to receive tracking information from the one or more message tracking data sources and parse the tracking information into one or more tracking data records;
a message tracking interface coupled to the message tracking monitor and one or more decision support subsystems, the message tracking interface operable to receive tracking data records and transmit the tracking data records to the one or more decision support subsystems.

23. The message tracking system as claimed in claim 22, further including:
one or more dynamically pluggable decision support interface modules coupled to the message tracking interface and the one or more decision support subsystems, wherein the one or more dynamically pluggable decision support interface modules in response to receiving the one or more tracking data records from the message tracking interface, transmit the one or more tracking data records to the one or more decision support subsystems.

24. The message tracking system as claimed in claim 22, wherein the tracking information includes message transactions on the Internet.
